(19) United States
(12) Patent Application Publication
(10) Pub. No.: US 2026/0056504 A1
(43) Pub. Date: Feb. 26, 2026

(54) OUTPUT-SHEET-STACKING DEVICE AND IMAGE FORMING SYSTEM

(71) Applicant: FUJIFILM BUSINESS INNOVATION CORP., Tokyo (JP)

(72) Inventor: Satoshi FUKADA, Kanagawa (JP)

(73) Assignee: FUJIFILM BUSINESS INNOVATION CORP., Tokyo (JP)

(21) Appl. No.: 19/059,514

(22) Filed: Feb. 21, 2025

(30) Foreign Application Priority Data
Aug. 26, 2024 (JP) 2024-144570

(51) Int. Cl. G03G 15/00

(52) U.S. Cl. CPC G03G 15/6573; G03G 2215/00421

(57) ABSTRACT

An output-sheet-stacking device includes: a tray including a rear wall and disposed in a downward direction from an outlet through which a sheet is output, the tray allowing the sheet output from the outlet to be stacked on the tray with the sheet being in a position in which a front edge of the sheet is positioned in an upward direction from a rear edge of the sheet; and at least one impact absorbing part provided on the rear wall of the tray and configured to, while receiving the rear edge of the sheet stacked on the tray, absorb an impact caused by a hit of the sheet, the at least one impact absorbing part including an inclined surface extending diagonally downward as proceeding in an output direction of the sheet and intersecting a surface of the rear wall when viewed from a side.

### CROSS-REFERENCE TO RELATED APPLICATIONS

This application is based on and claims priority under 35 USC 119 from Japanese Patent Application No. 2024-144570 filed August 26, 2024.

### BACKGROUND

### (i) Technical Field

The present disclosure relates to an output-sheet-stacking device and an image forming system.

### (ii) Related Art

Japanese Unexamined Patent Application Publication No. 2019-137533 discloses a sheet receiving device. The sheet receiving device includes an end fence and a placement table. The front edge of a sheet output from an outlet hits the end fence. The sheet that hits and drops is stacked on the placement table. The end fence in the sheet receiving device includes, in an upper region, an impact absorbing part that absorbs the impact caused by a hit of the sheet. The end fence further includes, in a lower region, a sheet alignment part that regulates the front edge of the sheet that hits the impact absorbing part and drops.

Japanese Unexamined Patent Application Publication No. 2016-183020 discloses an output-sheet-stacking device. The output-sheet-stacking device includes a stacking unit and a shape changing unit. The stacking unit stacks a printed medium that has been output, on a sheet output tray part including a stacking surface. With the shape changing unit, a portion of a wall surface with which the printed medium placed on the sheet output tray part is in contact is changed in shape according to the type of printed medium thickness.

Japanese Unexamined Patent Application Publication No. 2009-83957 discloses an image forming apparatus. The image forming apparatus includes a sheet feeding device, a sheet transport path, and an image forming section. Through the sheet transport path, the sheet fed from the sheet feeding device is transported to each part of an apparatus main body. The image forming section forms an image on the sheet transported through the sheet transport path. In addition, in the image forming apparatus, a sheet transport surface constituting the sheet transport path has plural ribs protruding and provided along a transport direction, and there are provided a sound absorbing member filling at least a part of gaps between the ribs and a sheet material covering the sound absorbing member and the ribs.

### SUMMARY

Aspects of non-limiting embodiments of the present disclosure relate to suppressing a stacking failure of a sheet, compared with a configuration in which an upper end of an impact absorbing part juts out from a surface of a rear wall of a tray when viewed from the side.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an output-sheet-stacking device including: a tray including a rear wall and disposed in a downward direction from an outlet through which a sheet is output, the tray allowing the sheet output from the outlet to be stacked on the tray with the sheet being in a position in which a front edge of the sheet is positioned in an upward direction from a rear edge of the sheet; and at least one impact absorbing part provided on the rear wall of the tray and configured to, while receiving the rear edge of the sheet stacked on the tray, absorb an impact caused by a hit of the sheet, the at least one impact absorbing part including an inclined surface extending diagonally downward as proceeding in an output direction of the sheet and intersecting a surface of the rear wall when viewed from a side.

### BRIEF DESCRIPTION OF THE DRAWINGS

Exemplary embodiments of the present disclosure will be described in detail based on the following figures, wherein:

FIG. 1 illustrates schematically the configuration of an image forming apparatus according to an exemplary embodiment of the present disclosure;

FIG. 2 illustrates schematically the configuration of an image forming section provided in the image forming apparatus according to the exemplary embodiment of the present disclosure;

FIG. 3 is a perspective view of an output-sheet-stacking device according to the exemplary embodiment of the present disclosure;

FIG. 4 is an enlarged view of a part indicated by arrow IV in FIG. 3;

FIG. 5 is a front view of a rear wall of a tray illustrated in FIG. 3 when viewed in a direction opposite to a sheet output direction;

FIG. 6 is a sectional view taken along line VI-VI in FIG. 4;

FIG. 7 is a sectional view taken along line VII-VII in FIG. 4;

FIG. 8 is a sectional view corresponding to FIG. 6 and illustrating a movement of a sheet P output from an outlet;

FIG. 9 is a sectional view corresponding to FIG. 6 and illustrating a movement of the sheet P output from the outlet;

FIG. 10 is a front view of a rear wall of a tray in an output-sheet-stacking device according to another exemplary embodiment of the present disclosure when viewed in the direction opposite to the sheet output direction;

FIG. 11 is a sectional view of an impact absorbing part in an output-sheet-stacking device according to another exemplary embodiment of the present disclosure;

FIG. 12 is a sectional view (corresponding to FIG. 6) illustrating a related part of an output-sheet-stacking device according to an alternative exemplary embodiment of the present disclosure; and

FIG. 13 is a sectional view (corresponding to FIG. 7) illustrating the impact absorbing part in the output-sheet-stacking device according to the alternative exemplary embodiment of the present disclosure.

### DETAILED DESCRIPTION

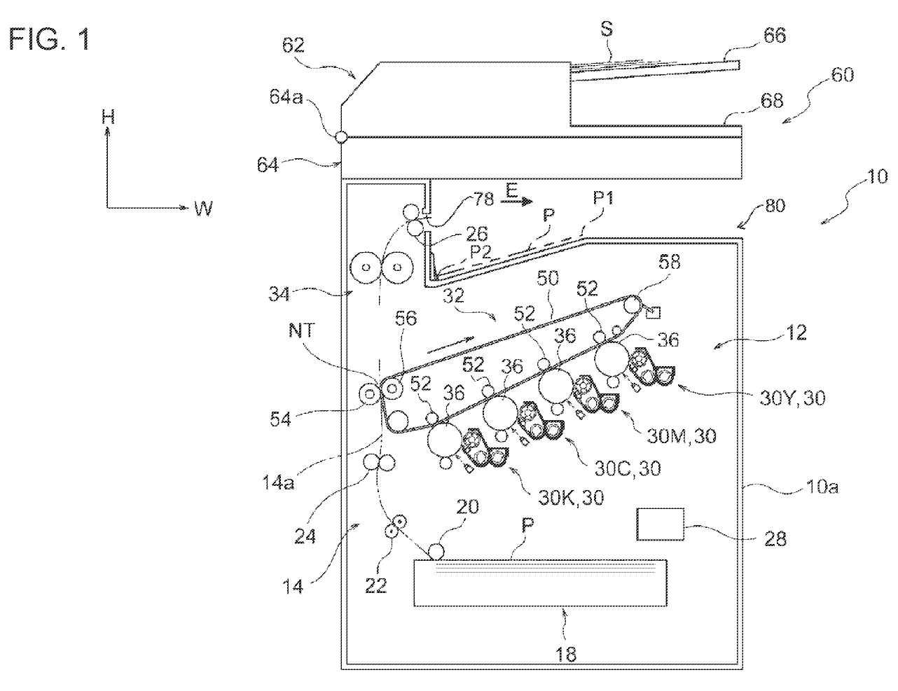

An example of an output-sheet-stacking device and an image forming apparatus according to an exemplary embodiment of the present disclosure will be described with reference to FIGS. 1 to 9. Note that, in each figure, an arrow H is the vertical direction and indicates an up-down direction of the apparatus. An arrow W is the horizontal direction while being orthogonal to the arrow H and indicates a width direction of the apparatus. An arrow D is the horizontal direction while being orthogonal to the arrow H and the arrow W and indicates a depth direction of the apparatus. The image forming apparatus according to the present exemplary embodiment is one example of an image forming system according to the present disclosure.

### Overall Configuration of Image Forming Apparatus 10

An image forming apparatus 10 includes, as FIG. 1 illustrates, an image forming section 12, an outlet 78, and an output-sheet-stacking device 80. The image forming section 12 has a function of forming an image (toner image) on a sheet P serving as a recording medium. The outlet 78 is an opening through which the sheet P on which an image has been formed at the image forming section 12 is output outside an apparatus main body 10a. The outlet 78 is an opening extending in the apparatus depth direction. Hereinafter, the direction where the outlet 78 extends (the apparatus depth direction) is referred to as a width direction of the outlet 78. The output-sheet-stacking device 80 has a function of stacking a sheet output from the outlet 78.

The image forming apparatus 10 further incudes an image reading section 60, a transport device 14, a storage unit 18, and a controller 28. The image reading section 60 has a function of reading an image from a document. The transport device 14 has a function of transporting a sheet P along a transport path 14a. The storage unit 18 has a function of storing a sheet P. The controller 28 has a function of controlling the entirety of the image forming apparatus 10.

In the image forming apparatus 10, the sheet P in the storage unit 18 is transported along the transport path 14a by the transport device 14. The image forming section 12 forms, based on image data, a toner image on the sheet P transported by the transport device 14. The sheet P on which the toner image has been formed is output outside the apparatus main body 10a through the outlet 78 by the transport device 14. The output sheet P is stacked at the output-sheet-stacking device 80. The image data may be image data read by the image reading section 60 or may be image data received from, for example, another device.

### Image Forming Section 12

The image forming section 12 includes, as FIG. 1 illustrates, plural toner image forming units 30 that form toner images in respective colors. The image forming section 12 further includes a transfer unit 32 that transfers the toner images formed at the toner image forming units 30, onto the sheet P. The image forming section 12 further includes a fixing device 34 that fixes the toner images having been transferred onto the sheet P by the transfer unit 32, to the sheet P.

### Toner Image Forming Unit 30

The plural toner image forming units 30 are provided so as to form toner images on a color basis. In the present exemplary embodiment, there are provided in total four toner image forming units 30Y, 30M, 30C, and 30K of four colors: yellow (Y), magenta (M), cyan (C), and black (K). Note that, when there is no need to distinguish yellow (Y), magenta (M), cyan (C), and black (K) from one another in the following description, Y, M, C, and K, which are to be added to the reference signs, will be omitted.

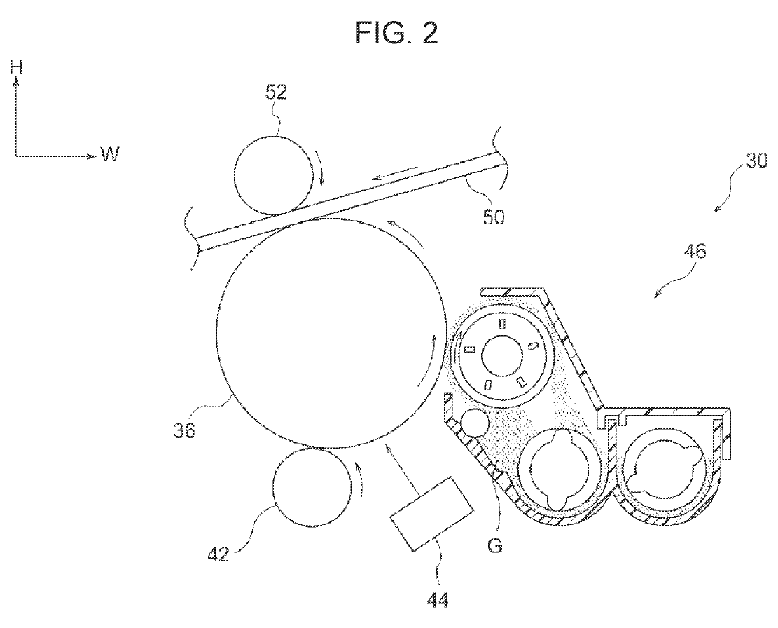

The toner image forming units 30 of the respective colors are configured in a similar manner except for the toners to be used. The toner image forming units 30 each include, as FIG. 2 illustrates, an image holding body 36, a charger 42, an exposure device 44, and a developing device 46. The image holding body 36 is a rotatable circular columnar body and has a function of holding a toner image on the outer periphery. The charger 42 has a function of charging the image holding body 36. The exposure device 44 has a function of forming an electrostatic latent image by irradiating the charged image holding body 36 with exposure light. The developing device 46 has a function of developing the electrostatic latent image into a toner image with a developer G containing a toner. The toner image forming unit 30 for each color forms an image of a corresponding color by using a toner of the corresponding color.

As FIG. 1 illustrates, the image holding bodies 36 of the respective colors are in contact with a transfer belt 50 (described in detail later) that circulates. The toner image forming units 30 of the colors: yellow (Y), magenta (M), cyan (C), and black (K) are arranged, in this order, from upstream in a circulating direction of the transfer belt 50 (refer to the arrow in FIG. 1).

### Transfer Unit 32

The transfer unit 32 includes, as FIG. 1 illustrates, the transfer belt 50 being endless and first transfer rollers 52. Each of the first transfer rollers 52 and the image holding body 36 of a corresponding color are disposed on opposite sides of the transfer belt 50. The first transfer roller 52 has a function of transferring the toner image formed on the image holding body 36, onto the transfer belt 50.

The transfer unit 32 includes a driving roller 56 and a winding roller 58. The transfer belt 50 is wound around the winding roller 58. The transfer belt 50 is also wound around the driving roller 56, and the driving roller 56 has a function of transmitting a rotational force to the transfer belt 50. With the rotation of the driving roller 56, the transfer belt 50 circulates in a direction of the arrow in FIG. 1.

The transfer unit 32 includes a second transfer roller 54. The second transfer roller 54 and the driving roller 56 are disposed on opposite sides of the transfer belt 50. The second transfer roller 54 has a function of transferring the toner images transferred onto the transfer belt 50, onto a sheet P. Note that, between the second transfer roller 54 and the transfer belt 50, a transfer nip part NT that transfers the toner images onto a sheet P is formed.

### Fixing Device 34

As FIG. 1 illustrates, the fixing device 34 is disposed downstream of the transfer nip part NT in a transport direction of a sheet P. The fixing device 34 has a function of, by applying heat and pressure to the toner images transferred onto the sheet P, fixing the toner images to the sheet P.

In the image forming section 12, the toner images of yellow (Y), magenta (M), cyan (C), and black (K) are first-transferred, in this order, onto the transfer belt 50 by the respective first transfer rollers 52. The second transfer roller 54 transfers the toner images from the transfer belt 50 onto the sheet P transported while being nipped between the transfer belt 50 and the second transfer roller 54. The sheet P onto which the toner images have been transferred is transported toward the fixing device 34. The fixing device 34 applies heat and pressure to the toner images transferred onto the sheet P and thus fixes the toner images to the sheet P.

### Transport Device 14

The transport device 14 includes, as FIG. 1 illustrates, a delivery roller 20, a prevention roller 22, an adjustment roller 24, and an output roller 26. The delivery roller 20 has a function of delivering the sheets P stored in the storage unit 18 to the transport path 14a. The prevention roller 22 has a function of preventing multi-feed of the sheets P delivered by the delivery roller 20. The adjustment roller 24 has a function of adjusting the timing of delivery of the sheet P to the transfer nip part NT. The output roller 26 has a function of outputting the sheet P outside the apparatus main body 10a.

### Output-Sheet-Stacking Device 80

As FIG. 1 illustrates, the output-sheet-stacking device 80 is disposed above the transfer unit 32. The output-sheet-stacking device 80 is a device that stacks the sheet P output from the outlet 78 by the output roller 26. The output-sheet-stacking device 80 will be described in detail later.

### Image Reading Section 60

As FIG. 1 illustrates, the image reading section 60 is disposed above the output roller 26. The image reading section 60 includes a document transport unit 62 and a document reading unit 64. The document transport unit 62 and the document reading unit 64 are coupled by a hinge part 64a provided on the document reading unit 64.

The image reading section 60 further includes a sheet feeding table 66 and an output table 68. The sheet feeding table 66 is a table for feeding a document S placed on an upper surface thereof to the document transport unit 62. The output table 68 is a table on which the document S that has been read by the document reading unit 64 and output is placed. The sheet feeding table 66 and the output table 68 are attached to the document transport unit 62.

In the image reading section 60, an upper surface (platen glass) of the document reading unit 64 is opened upward by rotating the document transport unit 62 around the hinge part 64a. The document reading unit 64 reads an image of the document S placed on the platen glass (not illustrated) disposed in the upper surface of the document reading unit 64. In addition, the document reading unit 64 reads an image of the document S transported by the document transport unit 62.

### Configuration of Related Part

Next, the output-sheet-stacking device 80 will be described in detail.

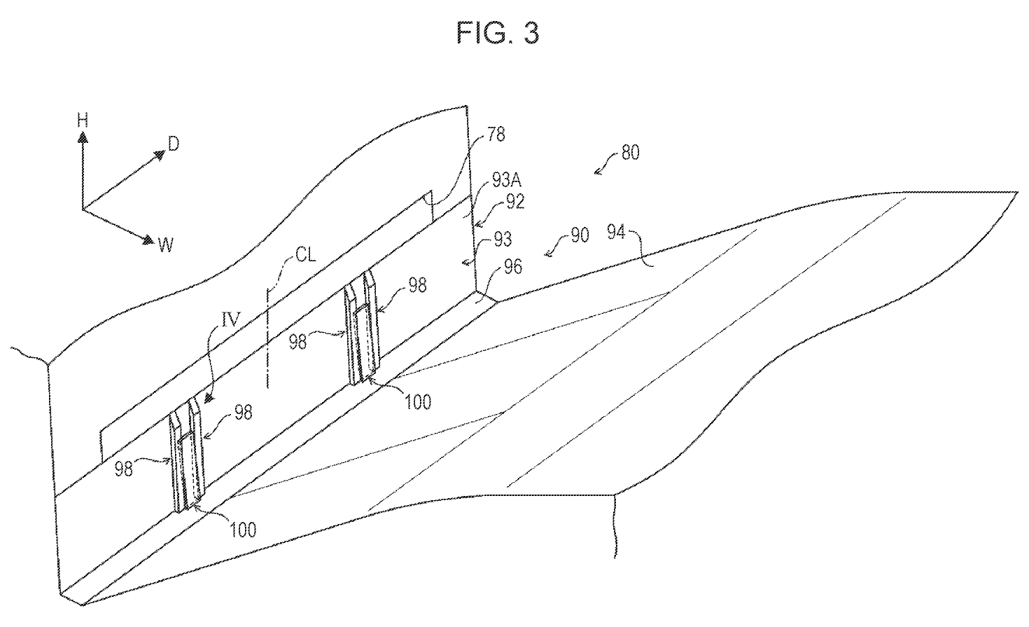

The output-sheet-stacking device 80 includes, as FIG. 3 illustrates, a tray 90 and a cushioning material 100 that is one example of an impact absorbing part.

### Tray 90

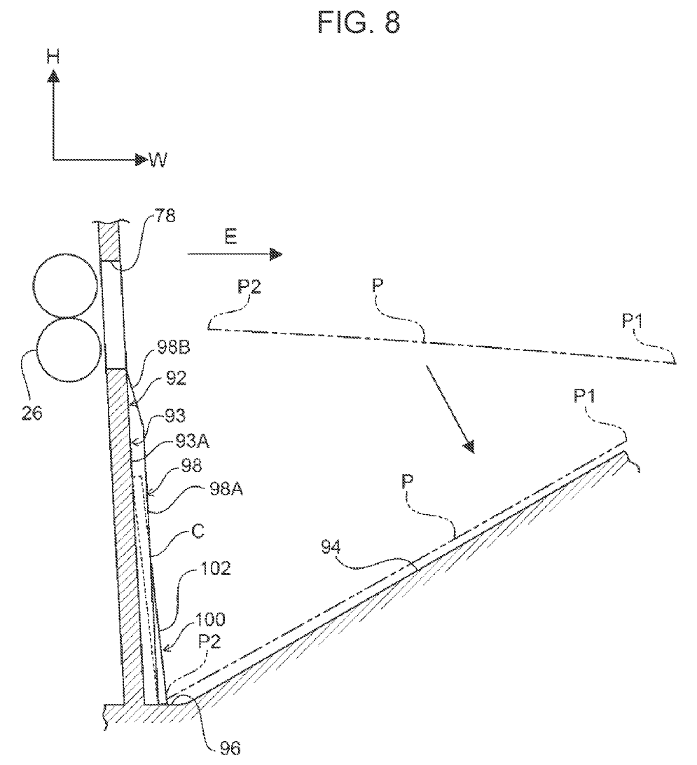

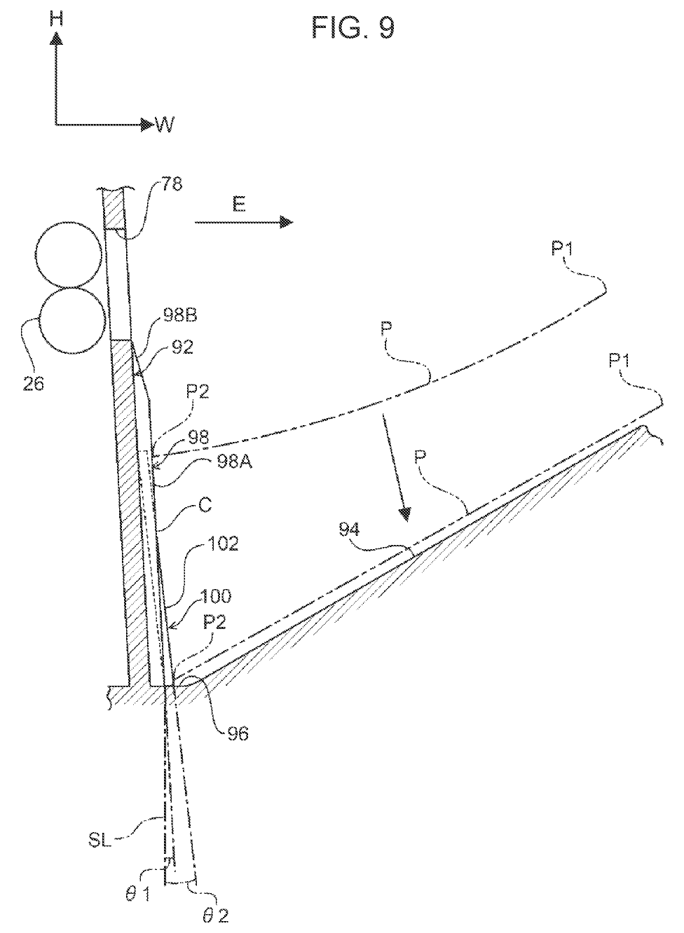

As FIGS. 1 and 3 illustrate, the tray 90 is disposed below the outlet 78 through which a sheet P is output. As FIGS. 8 and 9 illustrate, the tray 90 has a function of allowing the sheet P output from the outlet 78 to be stacked thereon with the sheet P being in a position in which a front edge P1 of the sheet P is above a rear edge P2 of the sheet P. Specifically, the tray 90 includes a rear wall 92, a support part 94, and a bottom part 96.

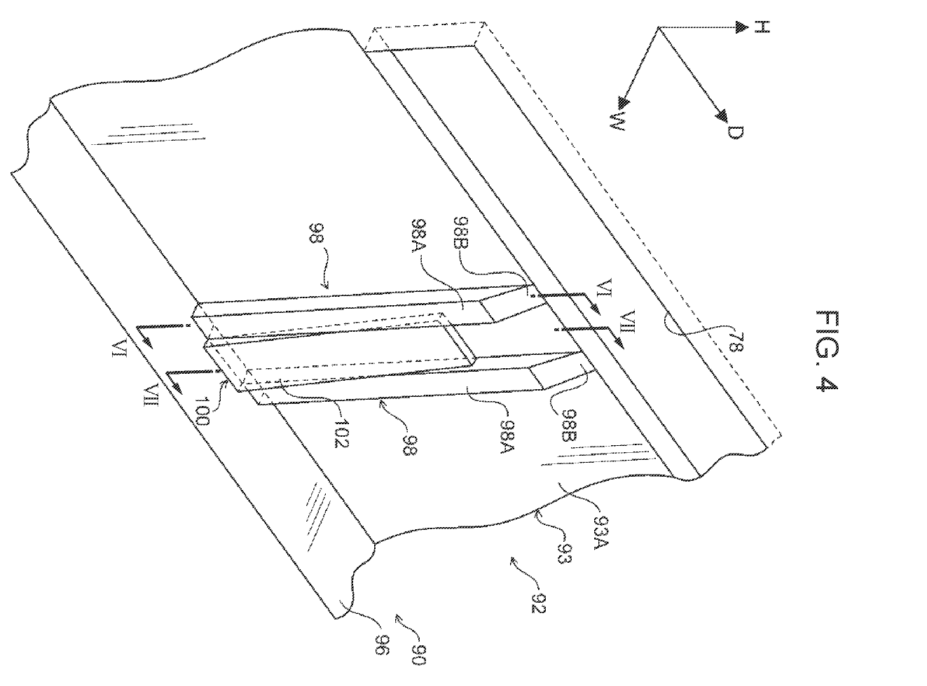

As FIGS. 3 and 4 illustrate, the rear wall 92 is a wall portion below the outlet 78 and extends in the up-down direction.

As FIGS. 8 and 9 illustrate, the support part 94 is a part that supports the sheet P output from the outlet 78. The support part 94 is positioned forward of the rear wall 92 in an output direction of the sheet P. Hereinafter, the output direction of the sheet P is referred to as a sheet output direction. In each figure, the sheet output direction is indicated by an arrow E.

As proceeding in the sheet output direction, the support part 94 is gradually increased in height in the up-down direction. Specifically, as FIG. 3 illustrates, the support part 94 is inclined diagonally upward to the right when the image forming apparatus 10 is viewed from the front. By being inclined as described above, the support part 94 may allow the sheet P to be stacked thereon with the sheet P being in a position in which the front edge P1 is above the rear edge P2. Note that "the image forming apparatus 10 is viewed from the front" means that the image forming apparatus 10 is viewed from one side in the apparatus depth direction. In addition, when the image forming apparatus 10 is viewed from the front, the support part 94 may be inclined, diagonally upward to the right, in a straight line or a curved line along a circular arc.

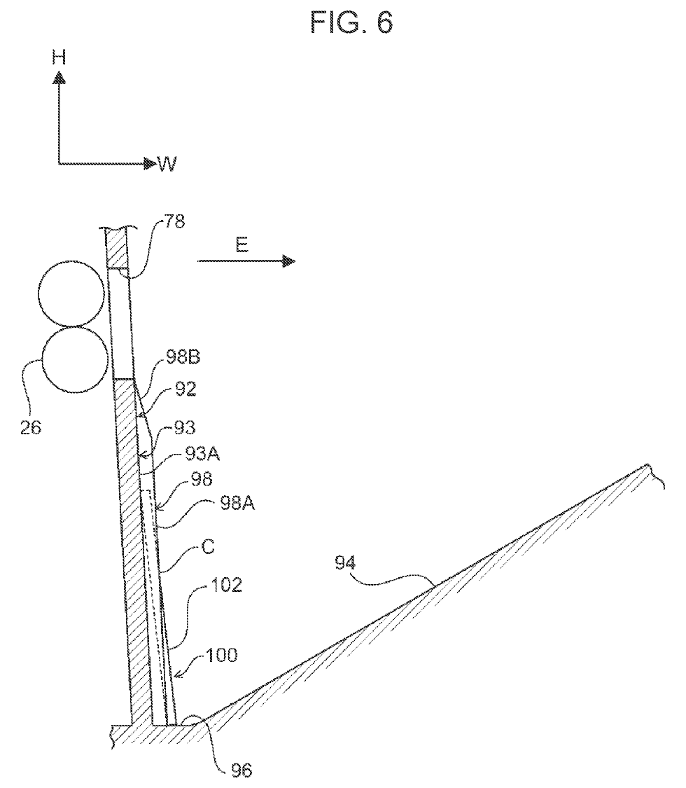

As FIGS. 3 and 6 illustrate, the bottom part 96 connects the rear wall 92 and the support part 94 to each other. Specifically, the bottom part 96 connects a lower end of the rear wall 92 and a lower end of the support part 94 to each other. Note that, in the present exemplary embodiment, the lower end of the support part 94 is also a rear end in the sheet output direction.

In addition, the rear wall 92 includes, as FIGS. 3 and 4 illustrate, a wall main body 93 and a pair of ribs 98. The paired ribs 98 each protrude from the wall main body 93 and extend downward. Specifically, the paired ribs 98 are each provided below the outlet 78. The paired ribs 98 each extend in the up-down direction to the bottom part 96. In addition, a protruding amount (protruding height), of a top surface 98A of each of the paired ribs 98, from a surface 93A of the wall main body 93 is constant toward the bottom part 96. Specifically, the top surface 98A of each of the paired ribs 98 is inclined diagonally downward as proceeding in the sheet output direction and has an angle θ1 relative to the up-down direction. In addition, an upper end portion 98B of each of the paired ribs 98 is inclined at a larger angle than the top surface 98A relative to the up-down direction. Note that the protruding amount of the top surface 98A, of each of the paired ribs 98, from the surface 93A is not necessarily constant toward the bottom part 96.

In the present exemplary embodiment, as one example, the spacing between the pair of ribs 98 is constant in the up-down direction, but the present disclosure is not limited thereto.

In the present exemplary embodiment, as one example, the thickness of each of the paired ribs 98 is constant in the up-down direction, but the present disclosure is not limited thereto.

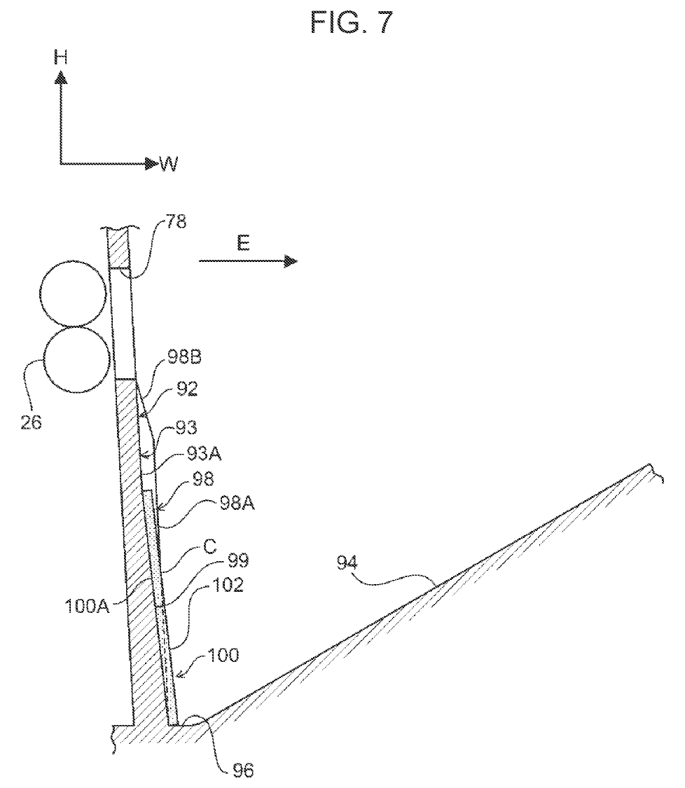

As FIG. 6 illustrates, between the pair of ribs 98, a support surface 99 (refer to FIG. 7) supporting the cushioning material 100 such that the cushioning material 100 is inclined diagonally downward as proceeding in the sheet output direction when viewed from the side (in the apparatus depth direction). Note that the "side" here refers to a left-right direction when the sheet output direction is a front-back direction. That is, "viewed from the side" refers to being viewed in the apparatus depth direction.

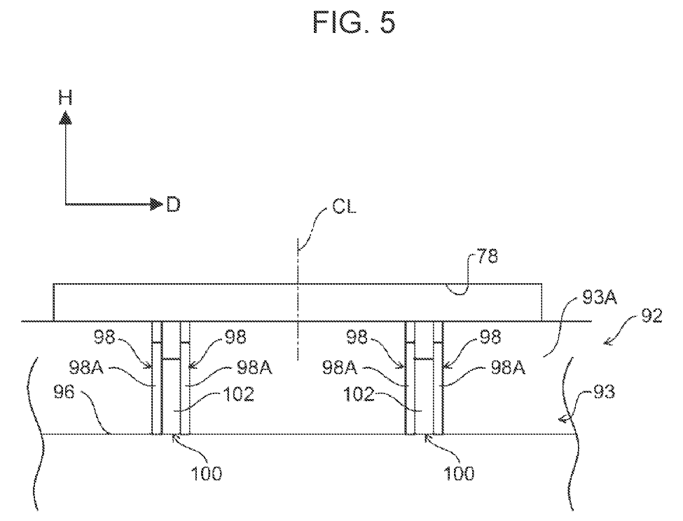

As FIG. 5 illustrates, the pair of ribs 98 is provided on the wall main body 93 on each of both sides, in the width direction of the outlet 78, of a center line CL passing through the center, in the width direction, of the outlet 78.

Note that the tray 90 according to the present exemplary embodiment is configured as a part of the apparatus main body 10a.

### Cushioning Material 100

As FIGS. 3 and 4 illustrate, the cushioning material 100 is provided on the rear wall 92. The cushioning material 100 has a function of, while receiving the rear edge P2 of the sheet P to be stacked on the tray 90, absorbing the impact caused by a hit of the sheet P.

As FIG. 5 illustrates, the cushioning materials 100 are provided on the rear wall 92 while being spaced in the width direction of the outlet 78. Specifically, the cushioning materials 100 are provided on two sides in the width direction of the outlet 78. More specifically, each of the cushioning materials 100 is provided between the corresponding pair of ribs 98. The cushioning material 100 is supported by the support surface 99 as FIG. 7 illustrates. The pairs of ribs 98 are provided on both sides, in the width direction, of the center line CL of the outlet 78. Thus, the cushioning materials 100 provided between the respective pairs of ribs 98 are also provided on both sides, in the width direction, of the center line CL of the outlet 78 (refer to FIG. 5).

The cushioning material 100 includes an inclined surface 102 extending diagonally downward as proceeding in the sheet output direction when viewed from the side (in the apparatus depth direction). Specifically, as FIGS. 6 and 7 illustrate, the inclined surface 102 extends diagonally downward to the right to intersect a surface 92A of the rear wall 92 when viewed from the side (in the apparatus depth direction). Note that the surface 92A of the rear wall 92 in the present exemplary embodiment includes the surface 93A of the wall main body 93, the top surfaces 98A of the paired ribs 98, and the support surfaces 99. In the present exemplary embodiment, the inclined surface 102 intersects the top surface 98A of each of the paired ribs 98 when viewed from the side (in the apparatus depth direction). Note that, in FIGS. 6 and 7, a reference sign C denotes a point at which the inclined surface 102 intersects the top surface 98A.

As FIG. 9 illustrates, the inclined surface 102 of the cushioning material 100 is inclined relative to the up-down direction at an angle θ2. Note that the angle θ2 is larger than the angle θ1. In FIG. 9, an angle of an extension line of the inclined surface 102 relative to a straight line SL along the up-down direction is indicated by θ2, and an angle of an extension line of the top surface 98A relative to the straight line SL is indicated by θ1.

A portion in the cushioning material 100 below the intersection point C when viewed from the side (in the apparatus depth direction) juts further downstream in the sheet output direction than the top surfaces 98A of the paired ribs 98. Thus, as FIG. 9 illustrates, the rear edge P2 of the sheet P is in contact with the top surface 98A of each of the paired ribs 98, in a region above the intersection point C. In addition, the rear edge P2 of the sheet P is in contact with the inclined surfaces 102 of the cushioning materials 100, in a region below the intersection point C. Here, there is a case where the rear edge P2 of the sheet P output from the outlet 78 hits the inclined surfaces 102 of the cushioning materials 100 and is stacked on the support part 94. There is also a case where the rear edge P2 of the sheet P output from the outlet 78 comes into contact with the top surface 98A of each of the paired ribs 98, slides down to the inclined surfaces 102 along each of the top surfaces 98A, and is stacked on the support part 94.

As FIG. 7 illustrates, the cushioning material 100 is a sheet-shaped member. Specifically, the cushioning material 100 is a sheet-shaped member having a constant thickness. Note that the present disclosure is not limited to this configuration, and the thickness of the cushioning material 100 may vary to the extent of error in manufacture.

As FIG. 7 illustrates, the cushioning material 100 is stuck on the rear wall 92 on one side 100A. Specifically, the one side 100A is stuck on the surface 92A of the rear wall 92 with adhesive tape. More specifically, the one side 100A is stuck on the support surface 99 between the pair of ribs 98. Note that such sticking of the one side 100A of the cushioning material 100 may be achieved by applying an adhesive to the support surface 99. Also, the one side 100A may be applied with an adhesive to be stuck on the support surface 99. Note that the one side 100A is a side of the cushioning material 100 having a sheet shape, and the opposite side thereto is the inclined surface 102.

### CONCLUSION

As described above, in the output-sheet-stacking device 80, as FIG. 7 illustrates, the rear edge P2 of the sheet P output from the outlet 78 hits the inclined surfaces 102 of the cushioning materials 100. By causing the rear edge P2 of the sheet P to hit the inclined surfaces 102 of the cushioning materials 100, a hit noise may be reduced compared with when the rear edge P2 of the sheet P hits the surface 92A of the rear wall 92. In addition, as FIG. 8 illustrates, when the sheet P is output, the rear edge P2 of the sheet P moves smoothly from the surface 92A of the rear wall 92 (the top surface 98A) to the inclined surface 102 of the cushioning material 100. Thus, in the output-sheet-stacking device 80, a stacking failure of the sheet P may be suppressed, compared with a configuration in which the upper end of the cushioning material 100 juts out from the surface 92A of the rear wall 92 of the tray 90 when viewed from the side (in the apparatus depth direction). Note that a "stacking failure" means variation in the sheet stacking position caused by the rear edge P2 of the sheet P getting caught on a corner portion of the cushioning material 100.

In the output-sheet-stacking device 80, as FIG. 5 illustrates, the cushioning materials 100 are spaced in the width direction of the outlet 78. Thus, in the output-sheet-stacking device 80, the cushioning materials 100 may receive rear edges P2 of sheets P of two or more sizes, compared with a configuration in which only one cushioning material 100 is provided on the rear wall 92.

In the output-sheet-stacking device 80, as FIG. 5 illustrates, the cushioning materials 100 are disposed on two sides in the width direction of the outlet 78. Thus, in the output-sheet-stacking device 80, the cushioning materials 100 may receive the rear edge P2 of the sheet P output from the outlet 78 at two sides in the width direction of the outlet 78, compared with a configuration in which the cushioning material 100 is provided only at the center of the rear wall 92 in the width direction of the outlet 78.

In the output-sheet-stacking device 80, as FIG. 4 illustrates, the cushioning material 100 is disposed between the pair of ribs 98. Thus, the cushioning material 100 may be positioned through an operation of providing the cushioning material 100 between the pair of ribs 98. That is, in the output-sheet-stacking device 80, variation in the position of the cushioning material 100 in the apparatus depth direction may be reduced, compared with a configuration in which the surface 92A of the rear wall 92 is a flat surface, and the cushioning material 100 is provided on the flat surface.

In the output-sheet-stacking device 80, as FIG. 7 illustrates, there is provided, between the pair of ribs 98, the support surface 99 supporting the cushioning material 100 such that the cushioning material 100 is inclined diagonally downward as proceeding in the sheet output direction when viewed from the side (in the apparatus depth direction). A surface of the cushioning material 100 serves as the inclined surface 102 by disposing the cushioning material 100 having a sheet shape on the support surface 99. As described above, in the output-sheet-stacking device 80, a general-purpose member having a sheet shape may be used as the cushioning material 100 by providing the support surface 99 between the pair of ribs 98.

In the output-sheet-stacking device 80, the one side 100A of the cushioning material 100 is stuck on the surface 92A of the rear wall 92. Specifically, the one side 100A of the cushioning material 100 is stuck on the support surface 99. Thus, in the output-sheet-stacking device 80, the cushioning material 100 may be easily attached to the rear wall 92, compared with a configuration in which the cushioning material 100 is attached to the rear wall 92 with a dedicated component.

### OTHER EXEMPLARY EMBODIMENTS

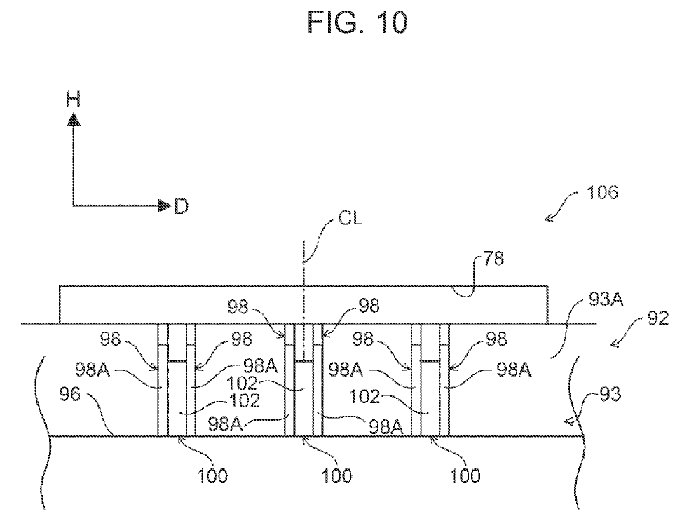

Although the cushioning materials 100 are provided on both sides of the center line CL of the outlet 78 in the above-described exemplary embodiment as FIG. 5 illustrates, the present disclosure is not limited to the configuration. For example, as with an output-sheet-stacking device 106 illustrated in FIG. 10, in addition to provision on both sides of the center line CL of the outlet 78, a cushioning material 100 may be disposed on the center line CL. In this case, such a pair of cushioning materials 100 may receive rear edges P2 of sheets P of two or more sizes. Note that the cushioning material 100 may be disposed only on the center line CL of the outlet 78.

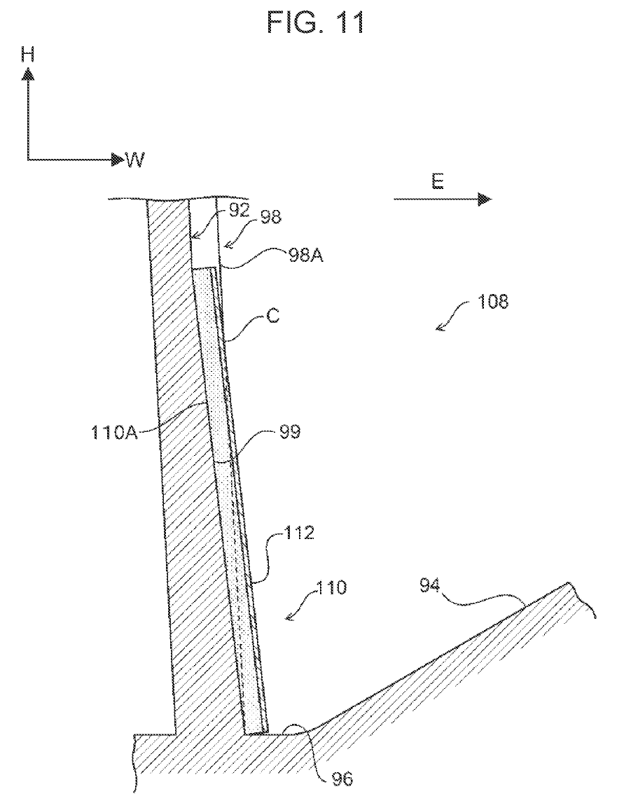

Although the cushioning material 100 is used as one example of the impact absorbing part in the above-described exemplary embodiments, the present disclosure is not limited to the configuration. For example, as with an output-sheet-stacking device 108 illustrated in FIG. 11, a cushioning material 110 including a surface on which a film 112 is stuck may be used as one example of the impact absorbing part. Specifically, the film 112 having frictional resistance lower than that of the cushioning material 110 is stuck on a side, of the cushioning material 110, opposite to one side 110A that is stuck on the support surface 99. By sticking the film 112 on such an opposite side of the cushioning material 110 as describe above, the rear edge P2 of the sheet P smoothly slides down on the film 112. Thus, in the output-sheet-stacking device 108, a stacking failure of the sheet P may be suppressed, compared with a configuration in which a film having frictional resistance equal to or higher than that of the cushioning material 110 is stuck. Note that, in the form illustrated in FIG. 11, a surface of the film 112 serves as an inclined surface of the impact absorbing part.

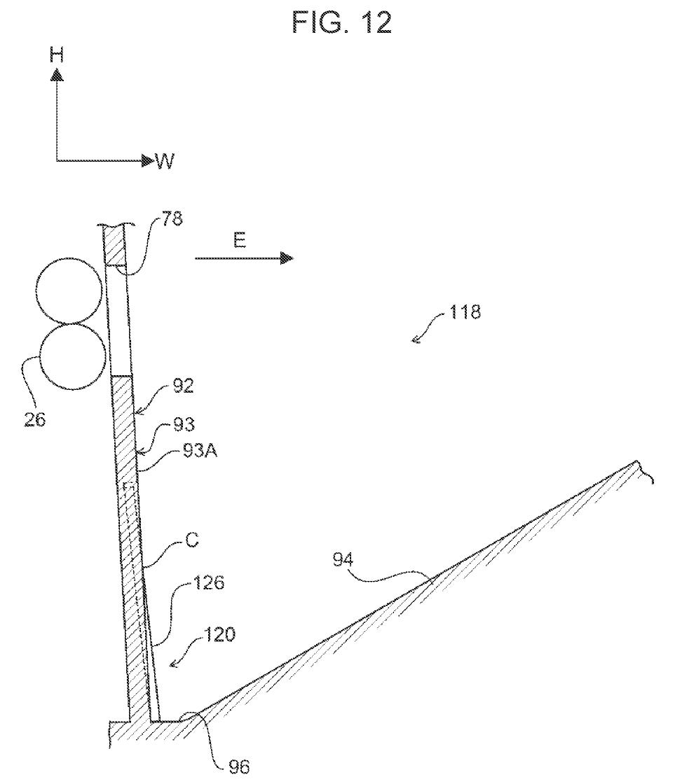

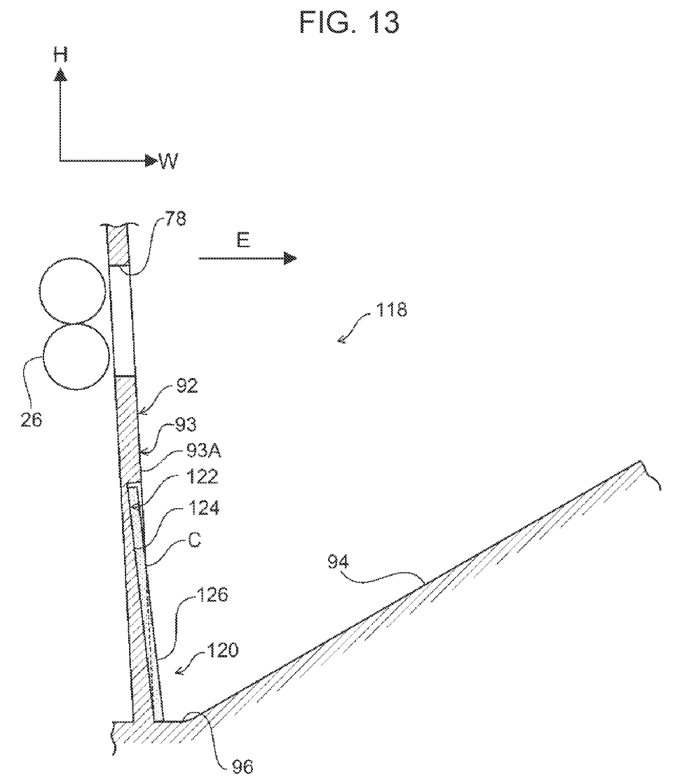

Although the pair of ribs 98 is provided on the rear wall 92 of the tray 90 in the above-described exemplary embodiments, the present disclosure is not limited to the configuration. For example, as with an output-sheet-stacking device 118 illustrated in FIGS. 12 and 13, the rear wall 92 of the tray 90 may include an accommodation recessed portion 122 accommodating at least an upper end portion of a cushioning material 120. In the output-sheet-stacking device 118, the rear wall 92 further includes a support surface 124 supporting the cushioning material 120 such that the cushioning material 120 is inclined diagonally downward as proceeding in the sheet output direction from the accommodation recessed portion 122 toward the bottom part 96 of the tray 90 when viewed from the side (in the apparatus depth direction). A surface of the cushioning material 120 is used as an inclined surface 126 by disposing the cushioning material 120 having a sheet shape on the support surface 124. As described above, in the output-sheet-stacking device 118, a general-purpose member having a sheet shape may be used as the cushioning material 120 by providing the support surface 99 in the rear wall 92.

Note that, although the present disclosure has so far been described in detail through specific exemplary embodiments, the present disclosure is not limited to the exemplary embodiments. It is apparent for those skilled in the art that various other exemplary embodiments are possible within the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

Appendix (((1))) An output-sheet-stacking device comprising: a tray including a rear wall and disposed in a downward direction from an outlet through which a sheet is output, the tray allowing the sheet output from the outlet to be stacked on the tray with the sheet being in a position in which a front edge of the sheet is positioned in an upward direction from a rear edge of the sheet; and at least one impact absorbing part provided on the rear wall of the tray and configured to, while receiving the rear edge of the sheet stacked on the tray, absorb an impact caused by a hit of the sheet, the at least one impact absorbing part including an inclined surface extending diagonally downward as proceeding in an output direction of the sheet and intersecting a surface of the rear wall when viewed from a side. (((2))) The output-sheet-stacking device according to (((1))), wherein: the at least one impact absorbing part comprises a plurality of impact absorbing parts, and the plurality of impact absorbing parts is provided in a spaced manner in a width direction of the outlet. (((3))) The output-sheet-stacking device according to (((1))) or (((2))), wherein: the at least one impact absorbing part comprises a plurality of impact absorbing parts, and at least some of the plurality of impact absorbing parts are disposed on two sides in a width direction of the outlet. (((4))) The output-sheet-stacking device according to (((3))), wherein: an impact absorbing part of the plurality of impact absorbing parts is disposed on a center line, in the width direction, of the outlet. (((5))) The output-sheet-stacking device according to (((1))), wherein: the rear wall includes a wall main body and a pair of ribs protruding from the wall main body and extending in the downward direction, the at least one impact absorbing part is provided between the pair of ribs, and the inclined surface intersects top surfaces, of the pair of ribs, included in the surface of the rear wall when viewed from a side. (((6))) The output-sheet-stacking device according to (((5))), wherein: the at least one impact absorbing part is a sheet-shaped member, and the tray includes, between the pair of ribs, a support surface supporting the at least one impact absorbing part such that the at least one impact absorbing part is inclined diagonally downward as proceeding in the output direction of the sheet when viewed from a side. (((7))) The output-sheet-stacking device according to (((1))), wherein: the at least one impact absorbing part is a sheet-shaped member, the rear wall includes an accommodation recessed portion accommodating at least an upper end portion of the at least one impact absorbing part, and the tray includes a support surface supporting the at least one impact absorbing part such that the at least one impact absorbing part is inclined diagonally downward as proceeding in the output direction of the sheet from the accommodation recessed portion toward a bottom part of the tray when viewed from a side. (((8))) The output-sheet-stacking device according to any one of (((1))) to (((7))), wherein: the at least one impact absorbing part is constituted by a cushioning material having a sheet shape, and one side of the cushioning material is stuck on the rear wall. (((9))) The output-sheet-stacking device according to (((8))), wherein: a film having frictional resistance lower than frictional resistance of the cushioning material is stuck on a side, of the cushioning material, opposite from the rear wall. (((10))) An image forming system comprising: an image forming section that forms an image on a sheet; an outlet through which a sheet with an image formed at the image forming section is output; and the output-sheet-stacking device, according to any one of (((1))) to (((9))), that stacks a sheet output from the outlet.

What is claimed is:

1. An output-sheet-stacking device comprising:
a tray including a rear wall and disposed in a downward direction from an outlet through which a sheet is output, the tray allowing the sheet output from the outlet to be stacked on the tray with the sheet being in a position in which a front edge of the sheet is positioned in an upward direction from a rear edge of the sheet; and at least one impact absorbing part provided on the rear wall of the tray and configured to, while receiving the rear edge of the sheet stacked on the tray, absorb an impact caused by a hit of the sheet, the at least one impact absorbing part including an inclined surface extending diagonally downward as proceeding in an output direction of the sheet and intersecting a surface of the rear wall when viewed from a side.

2. The output-sheet-stacking device according to claim 1, wherein:
the at least one impact absorbing part comprises a plurality of impact absorbing parts, and the plurality of impact absorbing parts is provided in a spaced manner in a width direction of the outlet.

3. The output-sheet-stacking device according to claim 1, wherein:
the at least one impact absorbing part comprises a plurality of impact absorbing parts, and at least some of the plurality of impact absorbing parts are disposed on two sides in a width direction of the outlet.

4. The output-sheet-stacking device according to claim 3, wherein:
an impact absorbing part of the plurality of impact absorbing parts is disposed on a center line, in the width direction, of the outlet.

5. The output-sheet-stacking device according to claim 1, wherein:
the rear wall includes a wall main body and a pair of ribs protruding from the wall main body and extending in the downward direction, the at least one impact absorbing part is provided between the pair of ribs, and the inclined surface intersects top surfaces, of the pair of ribs, included in the surface of the rear wall when viewed from a side.

6. The output-sheet-stacking device according to claim 5, wherein:
the at least one impact absorbing part is a sheet-shaped member, and the tray includes, between the pair of ribs, a support surface supporting the at least one impact absorbing part such that the at least one impact absorbing part is inclined diagonally downward as proceeding in the output direction of the sheet when viewed from a side.

7. The output-sheet-stacking device according to claim 1, wherein:
the at least one impact absorbing part is a sheet-shaped member, the rear wall includes an accommodation recessed portion accommodating at least an upper end portion of the at least one impact absorbing part, and the tray includes a support surface supporting the at least one impact absorbing part such that the at least one impact absorbing part is inclined diagonally downward as proceeding in the output direction of the sheet from the accommodation recessed portion toward a bottom part of the tray when viewed from a side.

8. The output-sheet-stacking device according to claim 1, wherein:
the at least one impact absorbing part is constituted by a cushioning material having a sheet shape, and one side of the cushioning material is stuck on the rear wall.

9. The output-sheet-stacking device according to claim 8, wherein:
a film having frictional resistance lower than frictional resistance of the cushioning material is stuck on a side, of the cushioning material, opposite from the rear wall.

10. An image forming system comprising:
an image forming section that forms an image on a sheet; an outlet through which a sheet with an image formed at the image forming section is output; and
the output-sheet-stacking device, according to claim 1, that stacks a sheet output from the outlet.

11. An image forming system comprising:
an image forming section that forms an image on a sheet; an outlet through which a sheet with an image formed at the image forming section is output; and
the output-sheet-stacking device, according to claim 2, that stacks a sheet output from the outlet.

12. An image forming system comprising:
an image forming section that forms an image on a sheet; an outlet through which a sheet with an image formed at the image forming section is output; and
the output-sheet-stacking device, according to claim 3, that stacks a sheet output from the outlet.

13. An image forming system comprising:
an image forming section that forms an image on a sheet; an outlet through which a sheet with an image formed at the image forming section is output; and
the output-sheet-stacking device, according to claim 4, that stacks a sheet output from the outlet.

14. An image forming system comprising:
an image forming section that forms an image on a sheet; an outlet through which a sheet with an image formed at the image forming section is output; and
the output-sheet-stacking device, according to claim 5, that stacks a sheet output from the outlet.

15. An image forming system comprising:
an image forming section that forms an image on a sheet; an outlet through which a sheet with an image formed at the image forming section is output; and
the output-sheet-stacking device, according to claim 6, that stacks a sheet output from the outlet.

16. An image forming system comprising:
an image forming section that forms an image on a sheet; an outlet through which a sheet with an image formed at the image forming section is output; and
the output-sheet-stacking device, according to claim 7, that stacks a sheet output from the outlet.

17. An image forming system comprising:
an image forming section that forms an image on a sheet; an outlet through which a sheet with an image formed at the image forming section is output; and
the output-sheet-stacking device, according to claim 8, that stacks a sheet output from the outlet.

18. An image forming system comprising:
an image forming section that forms an image on a sheet; an outlet through which a sheet with an image formed at the image forming section is output; and
the output-sheet-stacking device, according to claim 9, that stacks a sheet output from the outlet.
